(19) United States
(12) Patent Application Publication
(10) Pub. No.: US 2026/0289121 A1
(43) Pub. Date: Sep. 24, 2026

(54) APPARATUS AND METHOD FOR QUANTITATIVE ANALYSIS OF QUALITATIVE LINGUISTIC EVALUATION REGARDING PLANTS AND GROWTH ENVIRONMENT

(71) Applicant: KOREA ELECTRONICS TECHNOLOGY INSTITUTE, Seongnam-si (KR)

(72) Inventors: Min Goo LEE, Seoul (KR); Yong Kuk PARK, Seoul (KR)

(21) Appl. No.: 19/530,008

(22) Filed: Feb. 4, 2026

(30) Foreign Application Priority Data
Mar. 18, 2025 (KR) 10-2025-0034570

(51) Int. Cl. G06F 40/284; G06F 16/335; G06F 16/338

(52) U.S. Cl. CPC G06F 40/284; G06F 16/335; G06F 16/338

(57) ABSTRACT

An apparatus for quantitative analysis of qualitative linguistic evaluation regarding plants and growth environment generates a token sequence by dividing a received qualitative linguistic evaluation sentence into tokens in units of morphemes and pre-processing the tokens. The apparatus learns the sentence based on a deep learning model using the token sequence, and generates an output value of the deep learning model representing a degree of positivity or negativity of the sentence using an activation function. The apparatus calculates the output value as an evaluation score for the sentence, calculates an evaluation grade for the sentence by dividing the evaluation score into predetermined intervals, analyzes a reaction value for each morpheme that quantitatively represents an influence of each morpheme on sentiment of the sentence by calculating the evaluation score of a predicted sentence, and generates an image by visualizing the evaluation score, the evaluation grade, and/or the reaction value.

### CROSS REFERENCE TO RELATED APPLICATION

The present application claims priority to Korean Patent Application No. KR 10-2025-0034570 filed on Mar. 18, 2025 in the Korean Intellectual Property Office, the entire contents of which are incorporated herein for all purposes by this reference.

### BACKGROUND

### Technical Field

The present disclosure relates to an apparatus and method for quantitative analysis of qualitative linguistic evaluation regarding plants and growth environment provided by an evaluator for managing the internal environment of a plant factory.

### Description of Related Technology

In modern society, as problems such as climate change and resource scarcity intensify, traditional agricultural methods centered on open-field cultivation are facing significant limitations. For instance, extreme weather events, such as typhoons, heavy rain, heavy snow, droughts, and desertification, along with water and energy shortages not only reduce crop productivity but also hinder the progress of sustainable agriculture.

Consequently, new types of plant cultivation methods that allow for stable and efficient growth without relying on the natural environment are emerging.

### SUMMARY

One aspect is an apparatus and method for quantitatively analyzing qualitative linguistic evaluations, which can secure objectivity and consistency by quantitatively analyzing qualitative linguistic evaluations provided by an evaluator regarding plants and a growth environment in order to manage the internal environment of a plant factory.

Another aspect is an apparatus for quantitative analysis of qualitative linguistic evaluation regarding plants and growth environment that includes a natural language processing unit configured to generate a token sequence by dividing a received qualitative linguistic evaluation sentence regarding plants and growth environment into tokens in units of morphemes and pre-processing the tokens; a sentiment learning unit configured to learn the sentence based on a deep learning model using the token sequence, and to generate an output value of the deep learning model representing a degree of positivity or negativity of the sentence using an activation function; a sentiment analysis unit configured to calculate the output value as an evaluation score for the sentence, to calculate an evaluation grade for the sentence by dividing the evaluation score into predetermined intervals, and to analyze a reaction value for each morpheme that quantitatively represents an influence of each morpheme on sentiment of the sentence by calculating the evaluation score of a predicted sentence generated by progressively adding the tokens constituting the token sequence; and a visualization unit configured to generate an image by visualizing at least one of the evaluation score, the evaluation grade, and the reaction value for each morpheme.

According to an embodiment of the present disclosure, the sentiment analysis unit may be configured to analyze the reaction value for each morpheme by generating an i-th predicted sentence to which an i-th token of the token sequence is added, calculating the evaluation score by inputting the i-th predicted sentence into the sentiment learning unit, calculating a difference in the evaluation scores between of the i-th predicted sentence and an (i−1)-th predicted sentence, and storing the calculated difference in a response history variable in a list form.

According to an embodiment of the present disclosure, the natural language processing unit may include a filtering module configured to receive the sentence and filter the sentence into a normalized form; a tokenization module configured to tokenize the filtered sentence into morpheme units and to remove stop words; and a token sequence module configured to generate the token sequence by encoding and padding the tokens.

According to an embodiment of the present disclosure, the sentiment learning unit may include an embedding module configured to convert the token sequence into vectors to learn semantic relationships between morphemes constituting the sentence; a deep learning module configured to learn a context of the sentence through a deep learning model based on a Recurrent Neural Network (RNN) using the vectors; and an activation function module configured to represent the degree of positivity or negativity of the sentence as the output value between 0 and 1 by using a sigmoid function as the activation function.

According to an embodiment of the present disclosure, the visualization unit may be configured to visualize the reaction value for each morpheme using at least one method of a key-size structure word cloud and a sequence structure timeline based on the reaction history variable.

Another aspect is a method for quantitative analysis of qualitative linguistic evaluation regarding plants and growth environment, performed by a quantitative analysis apparatus, that includes generating a token sequence by dividing a received qualitative linguistic evaluation sentence regarding plants and growth environment into tokens in units of morphemes and pre-processing the tokens; learning the sentence based on a deep learning model using the token sequence; generating an output value of the deep learning model representing a degree of positivity or negativity of the sentence using an activation function; calculating the output value as an evaluation score for the sentence and calculating an evaluation grade for the sentence by dividing the evaluation score into predetermined intervals; analyzing a reaction value for each morpheme that quantitatively represents an influence of each morpheme on sentiment of the sentence by calculating the evaluation score of a predicted sentence generated by progressively adding the tokens constituting the token sequence; and generating an image by visualizing at least one of the evaluation score, the evaluation grade, and the reaction value for each morpheme.

According to an embodiment of the present disclosure, analyzing the reaction value for each morpheme may include generating an i-th predicted sentence to which an i-th token of the token sequence is added; calculating the evaluation score of the i-th predicted sentence; calculating a difference in the evaluation scores between of the i-th predicted sentence and an (i−1)-th predicted sentence; and storing the calculated difference in a response history variable in a list form.

According to an embodiment of the present disclosure, generating the token sequence may include receiving the sentence and filtering the sentence into a normalized form; tokenizing the filtered sentence into morpheme units and removing stop words; and generating the token sequence by encoding and padding the tokens.

According to an embodiment of the present disclosure, learning the sentence may include converting the token sequence into vectors to learn semantic relationships between morphemes constituting the sentence; and learning a context of the sentence through a deep learning model based on a Recurrent Neural Network (RNN) using the vectors.

According to an embodiment of the present disclosure, generating the output value may include representing the degree of positivity or negativity of the sentence as the output value between 0 and 1 by using a sigmoid function as the activation function.

According to an embodiment of the present disclosure, generating an image may include visualizing the reaction value for each morpheme using at least one method of a key-size structure word cloud and a sequence structure timeline based on the reaction history variable.

The apparatus for quantitative analysis of qualitative linguistic evaluation according to the present disclosure may use the output value of a sigmoid function, which analyzes the sentiment of a sentence, as an evaluation score. This allows for precise measurement of sentiment intensity beyond a simple binary classification of positivity or negativity, and secures fairness and objectivity of evaluation results by quantitatively analyzing qualitative linguistic evaluations.

In addition, the apparatus for quantitative analysis of qualitative linguistic evaluation according to the present disclosure can analyze a reaction value for each morpheme that quantitatively represents the influence of each morpheme on the sentiment of a sentence. This is achieved by calculating evaluation scores of predicted sentences generated by progressively adding tokens that constitute a token sequence.

Furthermore, the apparatus for quantitative analysis of qualitative linguistic evaluation according to the present disclosure can visually express the influence of each morpheme on the sentiment of a sentence. This is done by visualizing the reaction values for each morpheme using at least one of a key-size structure word cloud and a sequence structure timeline.

Moreover, the apparatus for quantitative analysis of qualitative linguistic evaluation according to the present disclosure can quantitatively analyze and provide qualitative linguistic evaluations provided by an evaluator regarding plants and their growth environment, in order to manage the internal environment of a plant factory.

### BRIEF DESCRIPTION OF THE DRAWINGS

FIG. 1 is a block diagram illustrating an apparatus for quantitative analysis of qualitative linguistic evaluation according to an embodiment.

FIG. 2 is a diagram illustrating an example of an operation of a natural language processor unit of the quantitative analysis apparatus according to an embodiment.

FIGS. 3A and 3B are diagrams illustrating examples in which the quantitative analysis apparatus according to an embodiment provides visualized evaluation scores and grades.

FIGS. 4 and 5 are diagrams illustrating examples in which the quantitative analysis apparatus according to an embodiment provides evaluation grades based on grade sizes.

FIGS. 6A and 6B are diagrams illustrating examples in which the quantitative analysis apparatus according to an embodiment provides visualized reaction values for each morpheme.

FIGS. 7 to 10 are flowcharts illustrating a method for quantitative analysis of qualitative linguistic evaluation according to an embodiment.

### DETAILED DESCRIPTION

A plant factory is a facility that cultivates plants indoors by integrating agricultural technology with information technology (IT). The internal environment of a plant factory is primarily managed using quantitative data based on sensors. For example, environmental data such as temperature, humidity, illuminance, and carbon dioxide concentration are collected, stored, and analyzed to control the internal environment of the factory. Furthermore, the growth status of plants is managed by applying quantified growth indicators, such as height, stem thickness, leaf size and count, and fruit yield.

While management methods based on such quantitative data offer high accuracy and efficiency, the visual observation and sensory judgment performed by the operator of a plant factory can provide critical information that is difficult to capture through quantitative data alone. An operator can detect anomalies at an early stage by comparing the current growth state of plants with previous states or by contrasting them with surrounding plants. Moreover, an operator's sensory judgment regarding the environment is expressed through qualitative descriptions such as “cold”, “hot”, “humid”, or “bright”. Such linguistic evaluations can significantly contribute to the operator's comprehensive judgment of complex factors within the internal environment. Therefore, a management approach that combines qualitative evaluation with quantitative data can further refine and advance the operation of plant factories.

However, since qualitative evaluation inherently depends on the individual evaluating the plants and the growth environment, subjective factors, such as the evaluator's personal inclinations, experience, or daily mood, may influence the evaluation content. These variations in expression can make it difficult to achieve a consistent interpretation of the plants and their growth environment.

To resolve these issues, there is a need for technology that analyzes qualitative linguistic evaluations provided by evaluators regarding plants and growth environments into quantitative numerical values.

Now, embodiments of the present disclosure will be described in detail with reference to the accompanying drawings.

In the following description and the accompanying drawings, well known techniques may not be described or illustrated in detail to avoid unnecessarily obscuring the subject matter of the present disclosure. Throughout the drawings, the same or similar reference numerals denote the same or corresponding features consistently.

The terms and words used in the following description, drawings, and claims are not limited to the dictionary meanings thereof and are merely used by the inventor to enable a clear and consistent understanding of the disclosure. Thus, it will be apparent to those skilled in the art that the following description of various embodiments of the present disclosure is provided for illustration purposes only and not for the purpose of limiting the disclosure as defined by the appended claims and their equivalents.

An apparatus for the quantitative analysis of qualitative linguistic evaluations regarding plants and growth environments, according to an embodiment of the present disclosure, is a device that quantitatively analyzes qualitative linguistic evaluations provided by an evaluator regarding plants and their growth environments in order to manage the internal environment of a plant factory.

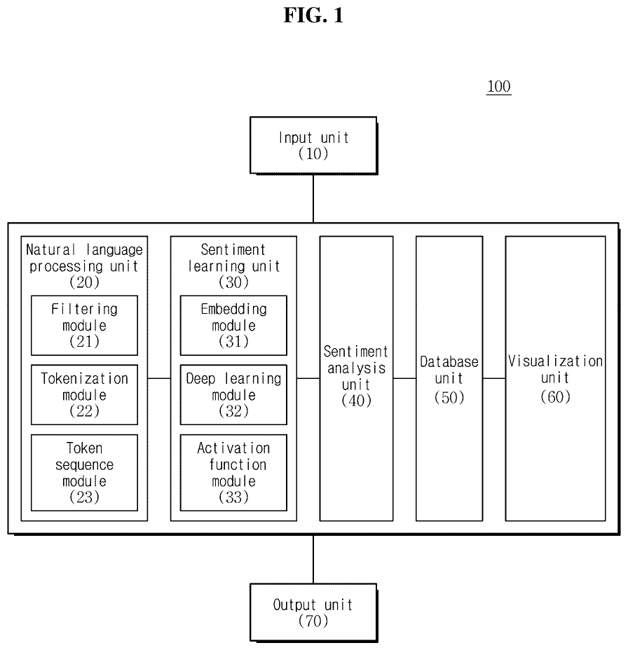

FIG. 1 is a block diagram illustrating an apparatus for quantitative analysis of qualitative linguistic evaluation according to an embodiment.

Referring to FIG. 1, the apparatus 100 for quantitative analysis of qualitative linguistic evaluation according to an embodiment includes an input unit (or an input interface) 10, a natural language processing unit (or a natural language processor) 20, a sentiment learning unit (or a sentiment learning processor) 30, a sentiment analysis unit (or a sentiment analysis processor) 40, a database unit (or a database) 50, a visualization unit (or a visualization processor) 60, and an output unit (or an output interface) 70.

The input unit 10 receives a qualitative linguistic evaluation sentence regarding plants and a growth environment. The natural language processing unit 20 divides the sentence received from the input unit 10 into tokens in units of morphemes and pre-processes the tokens to generate a token sequence. The sentiment learning unit 30 learns the sentence based on a deep learning model using the token sequence, and generates an output value of the deep learning model representing a degree of positivity or negativity of the sentence using an activation function. The sentiment analysis unit 40 calculates an evaluation score and an evaluation grade for the sentence based on the output value, and analyzes a reaction value for each morpheme that quantitatively represents the influence of each morpheme on the sentiment of the sentence based on the token sequence. The database unit 50 stores and manages learning information and value analysis results for qualitative linguistic evaluation sentences input in real-time. The visualization unit 60 generates an image by visualizing at least one of the evaluation score, the evaluation grade, and the reaction value for each morpheme. The output unit 70 outputs the image generated by the visualization unit 60.

Hereinafter, the configuration of the apparatus 100 for quantitative analysis of qualitative linguistic evaluation according to an embodiment will be described in more detail.

The input unit 10 may receive various types of information, such as numerical and character information, and may receive input signals related to function control of the quantitative analysis apparatus 100. The input unit 10 may include at least one of a keypad and a touch pad that generate an input signal based on a touch or manipulation. The input unit 10 may be configured in the form of a single touch panel (or touch screen) together with the output unit 70 to simultaneously perform input and display functions. In particular, the input unit 10 may receive a qualitative linguistic evaluation sentence regarding an evaluation target from a user.

For example, the qualitative linguistic evaluation sentence may be an evaluation sentence regarding a plant state, such as “The color of the leaves is light and the tips are drying out” or “The entire plant looks slightly droopy and its growth vitality seems to have decreased”. Also, the qualitative linguistic evaluation sentence may be an evaluation regarding a growth environment, such as “The interior feels a bit humid”, “The overall environment feels dark”, or “It feels slightly cool”.

The natural language processing unit 20 may divide the qualitative linguistic evaluation sentence received from the input unit 10 into tokens in units of morphemes and pre-process the tokens to generate a token sequence. Specifically, the natural language processing unit 20 may include a filtering module 21, a tokenization module 22, and a token sequence module 23.

The filtering module 21 may receive a sentence and filter it into a normalized form. For instance, the filtering module 21 may remove or correct non-standard expressions such as unnecessary symbols, punctuation marks, abbreviations, or spelling errors within the received sentence, thereby converting it into a consistent format suitable for analysis.

The tokenization module 22 may tokenize the filtered sentence into morpheme units and remove stop words. Tokenization refers to a process of segmenting a sentence into smaller units to convert it into an analyzable format. Specifically, the tokenization module 22 may tokenize the sentence into morphemes, which are the smallest linguistic units carrying meaning. Such tokenization enables a clearer identification of the sentence structure and meaning, allowing for an analysis of the specific role each morpheme plays within the sentence.

The tokenization module 22 may reduce the analysis time of the sentence by removing stop words, which are words that carry little or no significant meaning or importance. For example, stop words may include particles, interjections, or conjunctions such as “and”, “so”, and “but”.

The token sequence module 23 may generate a token sequence by encoding and padding the tokens. Encoding is a process of assigning a unique numerical ID to each token, which converts natural language into numerical data that a computer can understand. In addition, the token sequence module 23 may use padding to adjust sentences of varying lengths to a uniform length, enabling the quantitative analysis apparatus 100 to process diverse sentences in a consistent format. For example, if a sentence is shorter than a predetermined length, the token sequence module 23 may fill the remaining space with a specific value (typically 0) to ensure it has the same length as other sentences.

Through such encoding and padding, the token sequence module 23 may generate a token sequence in which the morphemes (i.e., tokens) constituting a sentence are arranged in sequence. Since the token sequence is converted while preserving the order and relationships of the morphemes, it enables the quantitative analysis apparatus 100 to identify the role each morpheme plays within the sentence.

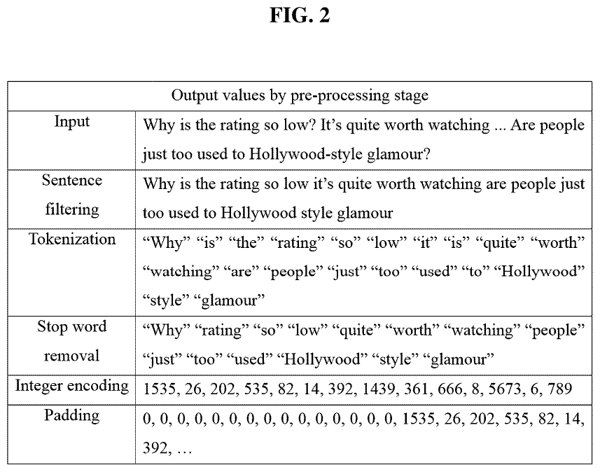

FIG. 2 is a diagram illustrating an example of an operation of a natural language processor unit of the quantitative analysis apparatus according to an embodiment.

Referring to FIG. 2, the natural language processing unit 20 may receive a qualitative linguistic evaluation sentence, “Why is the rating so low? It's quite worth watching . . . Are people just too used to Hollywood-style glamour?” and filter it into a normalized form such as “Why is the rating so low it's quite worth watching are people just too used to Hollywood style glamour”. Subsequently, the natural language processing unit 20 may tokenize the filtered sentence into morpheme units and remove stop words such as “is”, “the”, “it's”, “are” and “to”. Thereafter, the natural language processing unit 20 may encode each token of the sentence from which the stop words have been removed into integers and perform padding so that the sentence has a constant length, thereby generating a token sequence.

Returning to FIG. 1, the sentiment learning unit 30 may learn the sentence based on a deep learning model using the token sequence, and may generate an output value of the deep learning model representing a degree of positivity or negativity of the sentence using an activation function. Specifically, the sentiment learning unit 30 may include an embedding module 31, a deep learning module 32, and an activation function module 33.

The embedding module 31 may convert the token sequence into vectors to learn semantic relationships between morphemes constituting the sentence. The vectors converted by the embedding module 31 may reflect semantic similarities between the morphemes. For example, since both “fun” and “excellent” have positive meanings, the vectors of these two words may be positioned close to each other in a vector space. Conversely, since “fun” and “boring” have opposite meanings, they may be positioned far apart from each other. Through this, the embedding module 31 may learn similarities and differences between morphemes.

The deep learning module 32 may learn the context of the sentence through a deep learning model based on a Recurrent Neural Network (RNN) using the vectors. An RNN is a neural network structure suitable for processing sequence data and is effective in learning relationships between individual elements when the input data is continuous. In particular, the RNN can understand the context by reflecting sequential information, such as the arrangement order of a sentence. Specifically, the deep learning module 32 may learn the context of the sentence by using at least one of Long Short-Term Memory (LSTM), Bidirectional LSTM (BiLSTM), Deep RNN, and Gated Recurrent Unit (GRU), all of which are based on RNNs, as a deep learning model.

The activation function module 33 may represent the degree of positivity or negativity of the sentence as the output value of the deep learning model by using the activation function. The activation function is a function that determines the output value of the deep learning model. Preferably, the activation function module 33 may represent the degree of positivity or negativity of the sentence as an output value between 0 and 1 by using a sigmoid function as the activation function. In this case, as the output value of the sigmoid function is closer to 1, the sentence is interpreted as positive, and as the output value is closer to 0, the sentence may be interpreted as negative. That is, since the output value of the sigmoid function can be interpreted as a probability, it is suitable for binary classification of whether a sentence is positive or negative in sentiment analysis. For example, if the output value is greater than 0.5, it may be determined as positive, and if it is smaller, it may be determined as negative. The sigmoid function does not simply classify a sentence as positive or negative but can represent the degree of sentiment as continuous values. For instance, an output value of 0.7 may be interpreted as indicating that the sentence is generally positive while representing 0.3 of negative sentiment.

The sentiment analysis unit 40 may calculate an evaluation score and an evaluation grade for the sentence based on the output value generated by the activation function module 33. Specifically, the sentiment analysis unit 40 may calculate the output value as an evaluation score for the sentence and calculate an evaluation grade for the sentence by dividing the evaluation score into certain intervals.

In traditional sentiment analysis methods, a label processing method is used in which the output value between 0 and 1 is rounded based on 0.5 to simply binary-classify it as negative if it is close to 0 and positive if it is close to 1. While this method is advantageous for dichotomously classifying sentences, it has a limitation in that it fails to reflect subtle differences in sentiment.

In contrast, the sentiment analysis unit 40 may use the output value of the sigmoid function as it is as the evaluation score. For example, the quantitative analysis apparatus 100 may use an output value of 0.78 from the sigmoid function directly as an evaluation score of 78 points. Through this, the quantitative analysis apparatus 100 according to an embodiment can precisely measure the intensity of sentiment beyond simple positivity or negativity, and can secure fairness and objectivity for evaluation results by quantitatively analyzing qualitative linguistic evaluations.

The sentiment analysis unit 40 may calculate an evaluation grade by dividing the calculated evaluation score into certain intervals. Specifically, the sentiment analysis unit 40 may calculate a grade corresponding to each interval by dividing the evaluation score into ‘n’ intervals according to a set grade size. For example, when dividing a score of 100 points into five grades, the sentiment analysis unit 40 sets grade intervals such that 0 to 20 points is grade 5, 21 to 40 points is grade 4, 41 to 60 points is grade 3, 61 to 80 points is grade 2, and 81 to 100 points is grade 1, and then calculates the evaluation grade of the corresponding sentence.

As such, the apparatus 100 for quantitative analysis of descriptive sentences according to an embodiment represents the sentiment of a descriptive sentence as a grade, allowing for intuitive understanding of the sentiment of the sentence and easy comparison of sentiments between various sentences.

In addition, the sentiment analysis unit 40 may analyze a reaction value for each morpheme that quantitatively represents the influence of each morpheme on the sentiment of the sentence by calculating an evaluation score of a predicted sentence generated by progressively adding tokens constituting the token sequence.

Specifically, the sentiment analysis unit 40 may generate an i-th predicted sentence by adding an i-th token of a token sequence including ‘n’ tokens. In this case, an initial predicted sentence (i.e., 0-th predicted sentence) may be an empty sentence. The sentiment analysis unit 40 may input the generated i-th predicted sentence into the sentiment learning unit 30 to calculate an evaluation score, and may calculate a difference between the evaluation scores of the i-th predicted sentence and the (i−1)-th predicted sentence. Here, the initial evaluation score (i.e., the evaluation score of the 0-th predicted sentence) may be 50 points.

In this case, if the difference between the evaluation scores of the i-th predicted sentence and the (i−1)-th predicted sentence is a positive number, it can be interpreted that the i-th token contributes to the positive sentiment of the sentence. If the difference is a negative number, it can be interpreted that the i-th token contributes to the negative sentiment of the sentence. In particular, it can be interpreted that the greater the absolute value of the difference between the evaluation scores of the i-th predicted sentence and the (i−1)-th predicted sentence, the greater the contribution of the i-th token to the sentiment of the sentence.

The sentiment analysis unit 40 may store such a difference in evaluation scores in a reaction history variable in the form of a list. The sentiment analysis unit 40 may generate the reaction history variable by repeating this process until the last token of the token sequence.

For example, in a token sequence consisting of “AAA/BB/CCCC/DDD/EEE/FF/GGGG/HHH/II/JJJ/KKKK”, the sentiment analysis unit 40 may generate a first predicted sentence by adding the first token, “AAA”.

The sentiment analysis unit 40 may calculate the evaluation score of the first predicted sentence and calculate the difference from the evaluation score of the 0-th predicted sentence. If the difference in evaluation scores is +47.72, the sentiment analysis unit 40 may store +47.72 in the reaction history variable to generate r_history=[+47.72].

Next, the sentiment analysis unit 40 may generate a second predicted sentence, “AAA BB”, by adding the second token, “BB”, to the first predicted sentence.

The sentiment analysis unit 40 may calculate the evaluation score of the second predicted sentence and calculate the difference from the evaluation score of the first predicted sentence. If the difference in evaluation scores is −17.29, the sentiment analysis unit 40 may store −17.29 in the reaction history variable to generate r_history=[+47.72, −17.29].

Next, the sentiment analysis unit 40 may generate a third predicted sentence, “AAA BB CCCC”, by adding the third token, “CCCC”, to the second predicted sentence.

The sentiment analysis unit 40 may calculate the evaluation score of the third predicted sentence and calculate the difference from the evaluation score of the second predicted sentence. If the difference in evaluation scores is −14.79, the sentiment analysis unit 40 may store −14.79 in the reaction history variable to generate r_history=[+47.72, −17.29, −14.79].

The sentiment analysis unit 40 may repeat this process to calculate the evaluation score difference between the eleventh predicted sentence, “AAA BB CCCC DDD EEE FF GGGG HHH II JJJ KKKK” and the tenth predicted sentence, “AAA BB CCCC DDD EEE FF GGGG HHH II JJJ”, thereby generating a reaction history variable, r_history=[+47.72, −17.29, −14.79, +24.93, +4.54, −2.13, +5.86, −1.02, +0.39, +0.88, +0.23].

The database unit 50 may store and manage learning information for qualitative linguistic evaluation sentences input in real-time, along with quantitative analysis results regarding the sentiment of the sentences. Through this, the quantitative analysis apparatus 100 can create and continuously update a unique database for a specific evaluation target.

Specifically, the database unit 50 may store and manage information regarding the natural language processing unit 20 to ensure smooth operation and to improve the quality of natural language processing. In addition, the database unit 50 can continuously improve model performance by tracking and managing the learning processes of the natural language processing unit 20 and the sentiment learning unit 30. It can also store quantitative analysis results analyzed by the sentiment analysis unit 40, thereby establishing a data foundation for rapid retrieval of analysis results and analysis of specific patterns or trends.

The visualization unit 60 may generate an image by visualizing at least one of the evaluation score, the evaluation grade, and the reaction value for each morpheme.

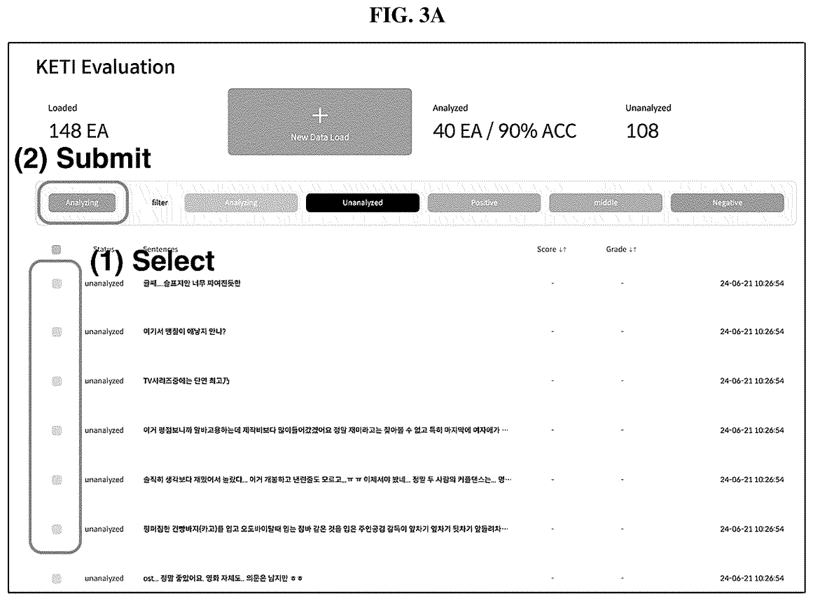

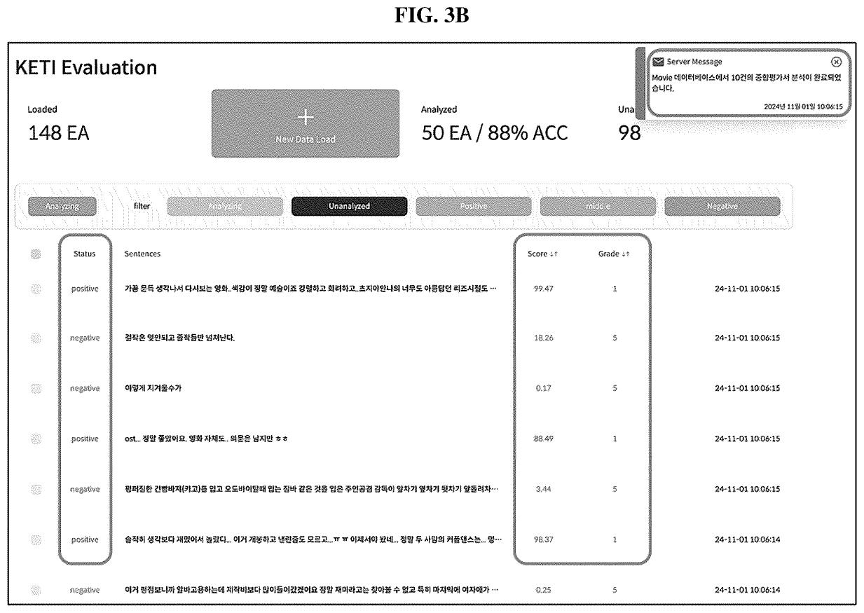

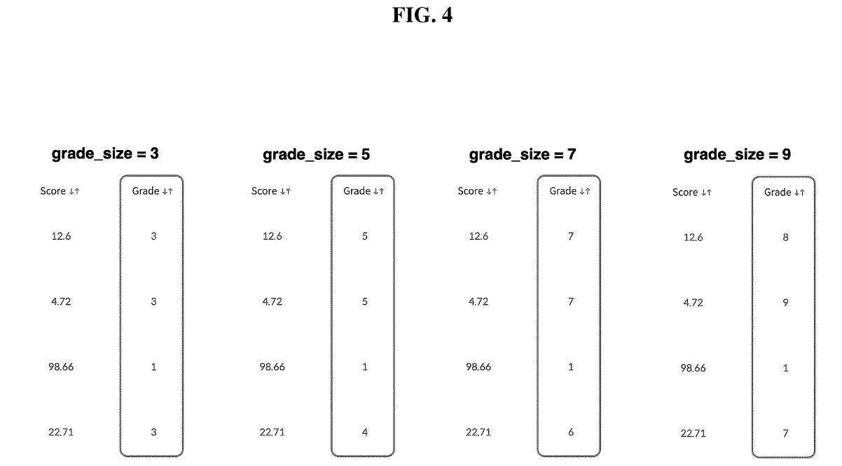

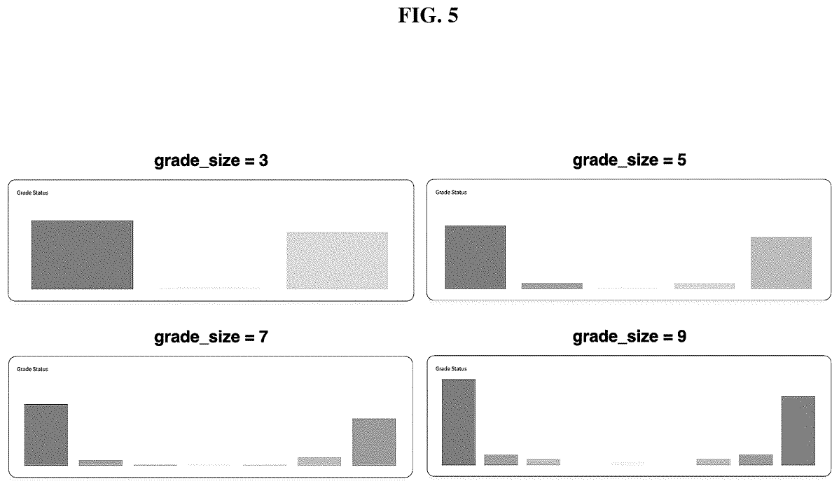

FIGS. 3A and 3B are diagrams illustrating examples in which the quantitative analysis apparatus according to an embodiment provides visualized evaluation scores and grades, and FIGS. 4 and 5 are diagrams illustrating examples in which the quantitative analysis apparatus according to an embodiment provides evaluation grades based on grade sizes.

As shown in FIG. 3A, when a qualitative linguistic evaluation sentence to be analyzed is selected, the quantitative analysis apparatus 100 may provide the evaluation score and grade corresponding to the selected sentence by displaying them numerically, as shown in FIG. 3B.

In particular, as shown in FIG. 4, the quantitative analysis apparatus 100 may calculate the grade of the corresponding score according to the grade size and display it numerically. In addition, as shown in FIG. 5, the quantitative analysis apparatus 100 may visualize the number of sentences belonging to each grade as a graph, thereby allowing an intuitive identification of the evaluation trend for the evaluation target.

The visualization unit 60 may visualize the reaction value for each morpheme using at least one method of a key-size structure word cloud and a sequence structure timeline based on the reaction history variable.

The key-size structure word cloud is a method of visualization by adjusting the size of each morpheme according to its contribution to the sentiment of the sentence. That is, the visualization unit 60 may adjust the size of the morpheme according to the magnitude of the absolute value of the reaction history variable (i.e., contribution). For example, the visualization unit 60 may display a morpheme with a large absolute value in the reaction history variable (i.e., high contribution) in a large size, and a morpheme with a small absolute value (i.e., low contribution) in a small size. Additionally or alternatively, the visualization unit 60 may differentiate the saturation or brightness of the color representing the morpheme according to the magnitude of the absolute value of the reaction history variable.

In addition, the visualization unit 60 may display morphemes that have a positive effect on the sentence and morphemes that have a negative effect in different colors. For example, the visualization unit 60 may display morphemes that positively affect the sentence in blue and morphemes that negatively affect the sentence in red.

The visualization unit 60 may visualize the process of generating predicted sentences and creating the reaction history variable to display the reaction values for each morpheme in the form of a sequence structure timeline. For example, the visualization unit 60 may provide a visualization of the evaluation scores of the generated predicted sentences and the reaction history variables of each token.

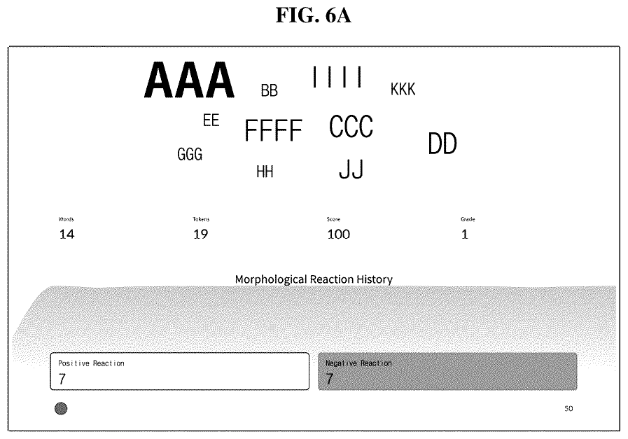

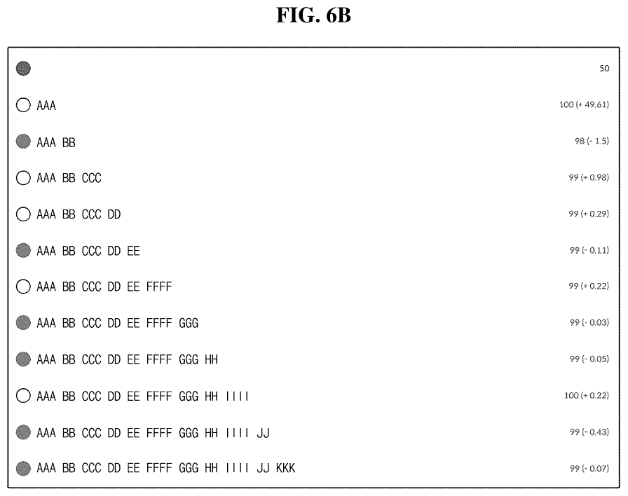

FIGS. 6A and 6B are diagrams illustrating examples in which the quantitative analysis apparatus according to an embodiment provides visualized reaction values for each morpheme. Specifically, FIG. 6A is a diagram visualizing the reaction values for each morpheme in a word cloud format, and FIG. 6B is a diagram visualizing the reaction values for each morpheme in a timeline format.

As shown in FIG. 6A, the quantitative analysis apparatus 100 may provide visualization of the number of words constituting the qualitative linguistic evaluation sentence, the number of tokens, the evaluation score, and the evaluation grade. Among the morphemes constituting the sentence, those with a higher contribution to the sentiment of the sentence are displayed in a larger size and darker color, thereby visualizing the reaction value for each morpheme. Furthermore, as shown in FIG. 6B, the quantitative analysis apparatus 100 may provide a visualization of the evaluation scores of the generated predicted sentences and the reaction history variables of each token. In this case, the quantitative analysis apparatus 100 displays the reaction history variable in blue if it is a positive number and in red if it is a negative number, allowing for an intuitive identification of the positive or negative sentiment represented by the corresponding morpheme.

Returning to FIG. 1, the output unit 70 displays information regarding a series of operation states and operation results occurring during the performance of functions of the quantitative analysis apparatus 100. The output unit 70 may include a liquid crystal display (LCD), a thin film transistor-liquid crystal display (TFT LCD), an organic light-emitting diode (OLED), a flexible display, a 3D display, or the like. When the output unit 70 is configured in the form of a touch screen, it may perform some or all of the functions of the input unit 10. In particular, the output unit 70 may output images generated through visualization by the visualization unit 60.

Hereinafter, a method for quantitative analysis of qualitative linguistic evaluation according to an embodiment will be described in more detail.

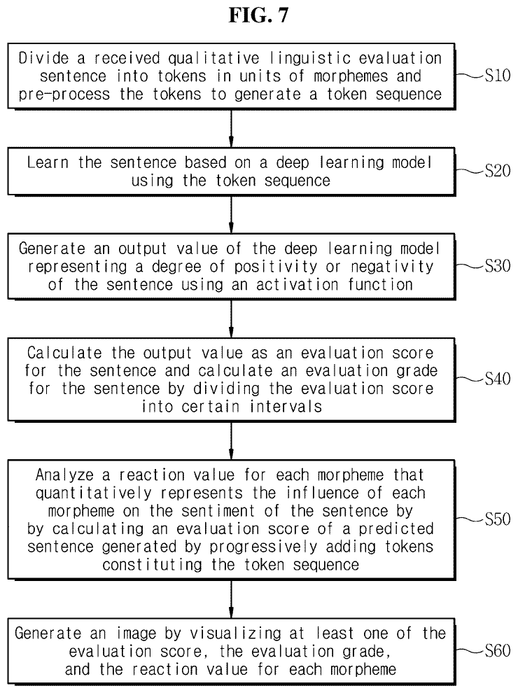

FIGS. 7 to 10 are flowcharts illustrating a method for quantitative analysis of qualitative linguistic evaluation according to an embodiment.

Referring to FIGS. 7 to 10, in step S10, an apparatus for quantitative analysis of qualitative linguistic evaluation divides a received qualitative linguistic evaluation sentence into tokens in units of morphemes and pre-processes the tokens to generate a token sequence.

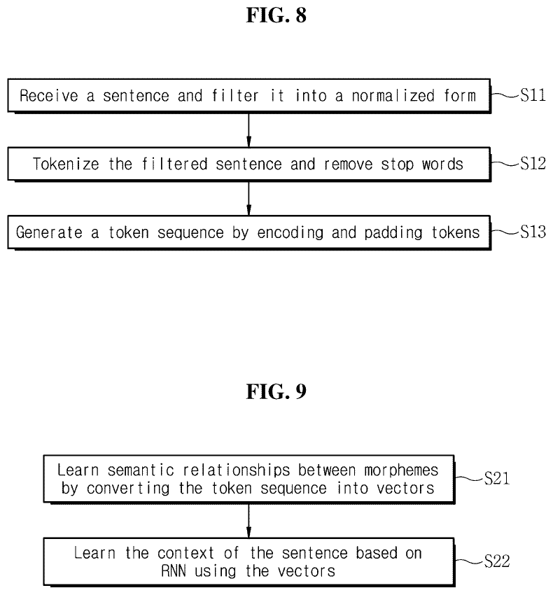

Specifically, the step S10 of generating the token sequence may include, as shown in FIG. 8, step S11 of receiving a sentence and filtering it into a normalized form, step S12 of tokenizing the filtered sentence and removing stop words, and step S13 of generating a token sequence by encoding and padding tokens.

For example, as shown in FIG. 2, the quantitative analysis apparatus may receive a qualitative linguistic evaluation sentence, “Why is the rating so low? It's quite worth watching . . . Are people just too used to Hollywood-style glamour?” and filter it into a normalized form such as “Why is the rating so low it's quite worth watching are people just too used to Hollywood style glamour”. Subsequently, the quantitative analysis apparatus may tokenize the filtered sentence into morpheme units and remove stop words such as “is”, “the”, “it's”, “are” and “to”. Thereafter, the quantitative analysis apparatus may encode each token of the sentence from which the stop words have been removed into integers and perform padding so that the sentence has a constant length, thereby generating a token sequence.

Next, in step S20, the quantitative analysis apparatus learns the sentence based on a deep learning model using the token sequence.

Specifically, the step S20 of learning the sentence may include, as shown in FIG. 9, step S21 of learning semantic relationships between morphemes by converting the token sequence into vectors, and step S22 of learning the context of the sentence based on a Recurrent Neural Network (RNN) using the vectors. Since the vectors reflect semantic similarities between morphemes, the quantitative analysis apparatus may learn similarities and differences between the morphemes. In addition, the quantitative analysis apparatus may learn the context of the sentence through a deep learning model based on an RNN, which is a neural network structure suitable for processing sequence data. For example, the quantitative analysis apparatus may learn the context of the sentence by using at least one of LSTM, BiLSTM, Deep RNN, and GRU as a deep learning model.

Next, in step S30, the quantitative analysis apparatus generates an output value of the deep learning model representing a degree of positivity or negativity of the sentence using an activation function.

In this step, the quantitative analysis apparatus may represent the degree of positivity or negativity of the sentence as an output value between 0 and 1 by using a sigmoid function as the activation function. As the output value of the sigmoid function is closer to 1, it is interpreted as a positive sentence, and as it is closer to 0, it may be interpreted as a negative sentence.

Next, in step S40, the quantitative analysis apparatus calculates the output value as an evaluation score for the sentence and calculates an evaluation grade for the sentence by dividing the evaluation score into certain intervals.

For example, the quantitative analysis apparatus may use an output value of 0.78 from the sigmoid function directly as an evaluation score of 78 points. Additionally, the quantitative analysis apparatus may calculate a grade corresponding to each interval by dividing the evaluation score into ‘n’ intervals according to a set grade size. For example, when dividing a score of 100 points into five grades, the quantitative analysis apparatus sets grade intervals such that 0 to 20 points is grade 5, 21 to 40 points is grade 4, 41 to 60 points is grade 3, 61 to 80 points is grade 2, and 81 to 100 points is grade 1, and then calculates the evaluation grade of the corresponding sentence.

Next, in step S50, the quantitative analysis apparatus analyzes a reaction value for each morpheme that quantitatively represents the influence of each morpheme on the sentiment of the sentence by calculating an evaluation score of a predicted sentence generated by progressively adding tokens constituting the token sequence.

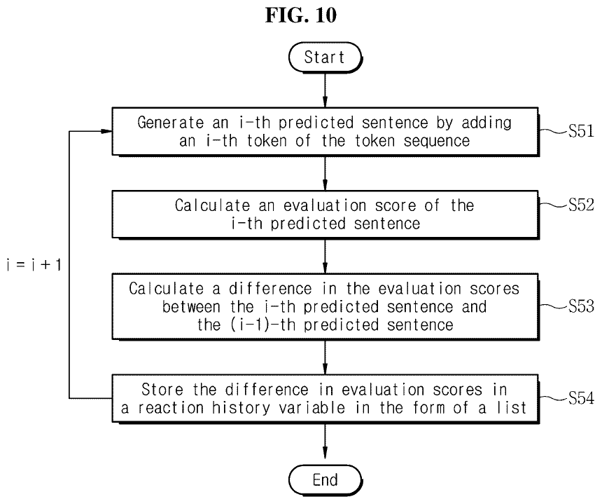

Specifically, the step S50 of analyzing the reaction value for each morpheme may include, as shown in FIG. 10, step S51 of generating an i-th predicted sentence by adding an i-th token of the token sequence, step S52 of calculating an evaluation score of the i-th predicted sentence, step S53 of calculating a difference in the evaluation scores between the i-th predicted sentence and the (i−1)-th predicted sentence, and step S54 of storing the difference in evaluation scores in a reaction history variable in the form of a list. The reaction history variable may be generated by repeating steps S51 to S54 until the last token.

If the difference between the evaluation scores of the i-th predicted sentence and the (i−1)-th predicted sentence is a positive number, it can be interpreted that the i-th token contributes to the positive sentiment of the sentence. If the difference is a negative number, it can be interpreted that the i-th token contributes to the negative sentiment of the sentence. In particular, it can be interpreted that the greater the absolute value of the difference between the evaluation scores of the i-th predicted sentence and the (i−1)-th predicted sentence, the greater the contribution of the i-th token to the sentiment of the sentence.

Finally, in step S60, the quantitative analysis apparatus generates an image by visualizing at least one of the evaluation score, the evaluation grade, and the reaction value for each morpheme.

In this step, the quantitative analysis apparatus may visualize the reaction value for each morpheme using at least one method of a key-size structure word cloud and a sequence structure timeline.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. An apparatus for quantitative analysis of qualitative linguistic evaluation regarding plants and growth environment, comprising:
a natural language processor configured to generate a token sequence by dividing a received qualitative linguistic evaluation sentence regarding plants and growth environment into tokens in units of morphemes and pre-processing the tokens;
a sentiment learning processor configured to learn the sentence based on a deep learning model using the token sequence, and to generate an output value of the deep learning model representing a degree of positivity or negativity of the sentence using an activation function;
a sentiment analysis processor configured to calculate the output value as an evaluation score for the sentence, to calculate an evaluation grade for the sentence by dividing the evaluation score into predetermined intervals, and to analyze a reaction value for each morpheme that quantitatively represents an influence of each morpheme on sentiment of the sentence by calculating the evaluation score of a predicted sentence generated by progressively adding the tokens constituting the token sequence; and
a visualization processor configured to generate an image by visualizing at least one of the evaluation score, the evaluation grade, and the reaction value for each morpheme,
the sentiment analysis processor further configured to:
analyze the reaction value for each morpheme by generating an i-th predicted sentence to which an i-th token of the token sequence is added,
calculate the evaluation score by inputting the i-th predicted sentence into the sentiment learning processor,
calculate a difference in the evaluation scores between of the i-th predicted sentence and an (i−1)-th predicted sentence, and
store the calculated difference in a response history variable in a list form.

2. The quantitative analysis apparatus of claim 1, wherein the natural language processor includes:
a filtering module configured to receive the sentence and filter the sentence into a normalized form;
a tokenization module configured to tokenize the filtered sentence into morpheme units and to remove stop words; and
a token sequence module configured to generate the token sequence by encoding and padding the tokens.

3. The quantitative analysis apparatus of claim 2, wherein the sentiment learning processor includes:
an embedding module configured to convert the token sequence into vectors to learn semantic relationships between morphemes constituting the sentence;
a deep learning module configured to learn a context of the sentence through a deep learning model based on a Recurrent Neural Network (RNN) using the vectors; and
an activation function module configured to represent the degree of positivity or negativity of the sentence as the output value between 0 and 1 by using a sigmoid function as the activation function.

4. The quantitative analysis apparatus of claim 3, wherein the visualization processor is configured to visualize the reaction value for each morpheme using at least one method of a key-size structure word cloud and a sequence structure timeline based on the reaction history variable.

5. A method for quantitative analysis of qualitative linguistic evaluation regarding plants and growth environment, performed by a quantitative analysis apparatus, the method comprising:
generating a token sequence by dividing a received qualitative linguistic evaluation sentence regarding plants and growth environment into tokens in units of morphemes and pre-processing the tokens;
learning the sentence based on a deep learning model using the token sequence;
generating an output value of the deep learning model representing a degree of positivity or negativity of the sentence using an activation function;
calculating the output value as an evaluation score for the sentence and calculating an evaluation grade for the sentence by dividing the evaluation score into predetermined intervals;
analyzing a reaction value for each morpheme that quantitatively represents an influence of each morpheme on sentiment of the sentence by calculating the evaluation score of a predicted sentence generated by progressively adding the tokens constituting the token sequence; and
generating an image by visualizing at least one of the evaluation score, the evaluation grade, and the reaction value for each morpheme,
wherein analyzing the reaction value for each morpheme includes:
generating an i-th predicted sentence to which an i-th token of the token sequence is added,
calculating the evaluation score of the i-th predicted sentence,
calculating a difference in the evaluation scores between of the i-th predicted sentence and an (i−1)-th predicted sentence, and
storing the calculated difference in a response history variable in a list form.

6. The quantitative analysis method of claim 5, wherein generating the token sequence includes:
receiving the sentence and filtering the sentence into a normalized form;
tokenizing the filtered sentence into morpheme units and removing stop words; and
generating the token sequence by encoding and padding the tokens.

7. The quantitative analysis method of claim 6, wherein learning the sentence includes:
converting the token sequence into vectors to learn semantic relationships between morphemes constituting the sentence; and
learning a context of the sentence through a deep learning model based on a Recurrent Neural Network (RNN) using the vectors.

8. The quantitative analysis method of claim 6, wherein generating the output value includes:
representing the degree of positivity or negativity of the sentence as the output value between 0 and 1 by using a sigmoid function as the activation function.

9. The quantitative analysis method of claim 8, wherein generating an image includes:
visualizing the reaction value for each morpheme using at least one method of a key-size structure word cloud and a sequence structure timeline based on the reaction history variable.
